(19) United States
(12) Patent Application Publication
(10) Pub. No.: US 2023/0251350 A1
(43) Pub. Date: Aug. 10, 2023

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventor: KAZUKI HIRAISHI, TOKYO (JP)

(21) Appl. No.: 18/004,679

(22) PCT Filed: Jun. 22, 2021
(86) PCT No.: PCT/JP2021/023503

§ 371 Date: Jan. 9, 2023

(30) Foreign Application Priority Data
Jul. 15, 2020 (JP) 2020-121447

(51) Int. Cl. G01S 7/40; G01S 13/931

(52) U.S. Cl. CPC G01S 7/40; G01S 13/931

(57) ABSTRACT

An information processing device (10) includes a generation unit (123) that acquires results of measurement from a first millimeter wave radar (3) and a second millimeter wave radar (5) (corresponding to an example of “a plurality of sensors”) mounted on a host vehicle (Vₛ) (corresponding to an example of “one mobile apparatus”), that uses, as reference points, other vehicles (Vₙ) and (V_{f}) (corresponding to an example of “other mobile apparatuses”) other than the host vehicle (Vₛ), extracted from the results of the measurement, and that generates calibration parameters between both radars (3) and (5).

### FIELD

The present disclosure relates to an information processing device, an information processing method, and an information processing program.

### BACKGROUND

In recent years, for the purpose of detecting information necessary for autonomous drive and drive assistance, a technology has been studied to combine information acquired from a plurality of in-vehicle sensors to obtain higher detection accuracy than that obtained from a single in-vehicle sensor.

Here, when information acquired from the plurality of in-vehicle sensors are used in combination, unless a relative arrangement relationship between the in-vehicle sensors is accurately grasped, accuracy of the combined information is reduced. In view of this point, for example, a technology has been proposed by which the in-vehicle sensors are calibrated on the basis of map information.

### CITATION LIST

### Patent Literature

Patent Literature 1: JP 2018-096715 A

### SUMMARY

### Technical Problem

However, the above-described conventional technology based on the map information cannot perform calibration in an area that has no corresponding map information. Furthermore, the calibration cannot be performed in an area that has a difference in the map information due to a change in environment caused by construction, disaster, or the like, even if the area has the corresponding map information.

In addition, even in an area that has no difference in the map information, in order to accurately perform the calibration, it is necessary to accurately estimate the position and attitude of a host vehicle in the first place.

Therefore, the present disclosure proposes an information processing device, an information processing method, and an information processing program that are configured to perform calibration, without being affected by the presence/absence of map information or a change in environment, and without depending on the position and attitude of a mobile apparatus itself.

### Solution to Problem

In order to solve the above problems, one aspect of an information processing device according to the present disclosure includes a generation unit that acquires results of measurement from a plurality of sensors mounted on one mobile apparatus, uses, as reference points, other mobile apparatuses other than the one mobile apparatus extracted from the results of measurement, and generates calibration parameters between the sensors.

### BRIEF DESCRIPTION OF DRAWINGS

FIG. 1 is a schematic explanatory diagram of an information processing method according to an embodiment of the present disclosure.

FIG. 2 is an explanatory diagram of calibration parameters.

FIG. 3 is a diagram illustrating an exemplary configuration of an information processing system according to an embodiment of the present disclosure.

FIG. 4 is a block diagram illustrating an exemplary configuration of an information processing device according to an embodiment of the present disclosure.

FIG. 5 is an explanatory diagram (1) of an extraction process.

FIG. 6 is an explanatory diagram (2) of the extraction process.

FIG. 7 is an explanatory diagram (3) of the extraction process.

FIG. 8 is a flowchart illustrating a processing procedure performed by the information processing device according to an embodiment of the present disclosure.

FIG. 9 is a flowchart illustrating a procedure for a calibration parameter generation process illustrated in FIG. 8.

FIG. 10 is a hardware configuration diagram illustrating an example of a computer implementing the functions of the information processing device.

### DESCRIPTION OF EMBODIMENTS

Embodiments of the present disclosure will be described below in detail with reference to the drawings. Note that in the following embodiments, the same portions are denoted by the same reference numerals and symbols, and a repetitive description thereof will be omitted.

Furthermore, the present disclosure will be described in the order of items shown below.
1. Overview of embodiment of present disclosure
2. Configuration of information processing system
   2–1. Overall configuration
   2–2. Configuration of information processing device
3. Processing procedure performed by information processing device
4. Modifications
   4–1. First Modification
   4–2. Second Modification
   4–3. Third Modification
   4–4. Other Modifications
5. Hardware configuration
6. Conclusion

### 1. Overview of Embodiment of Present Disclosure

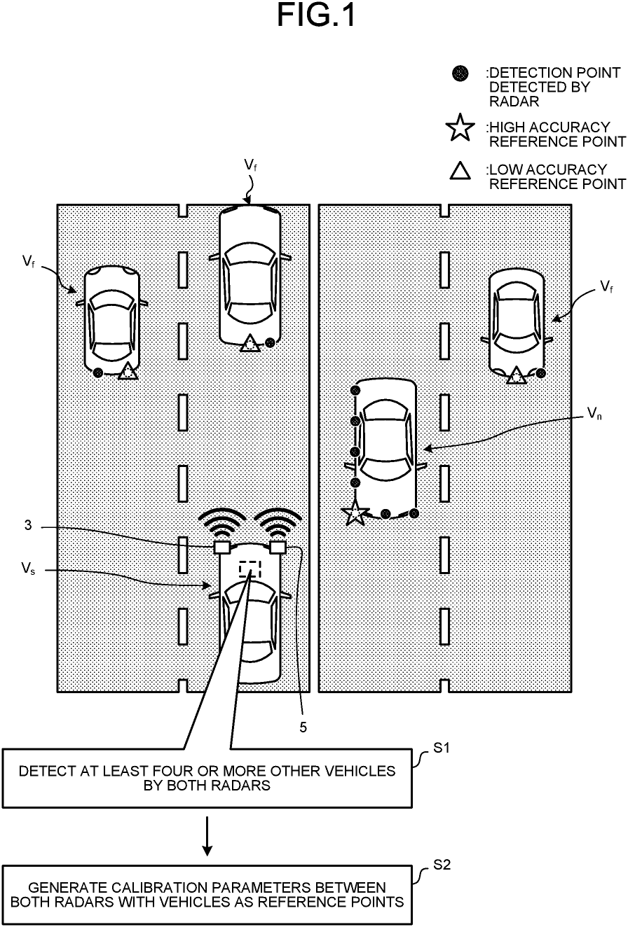

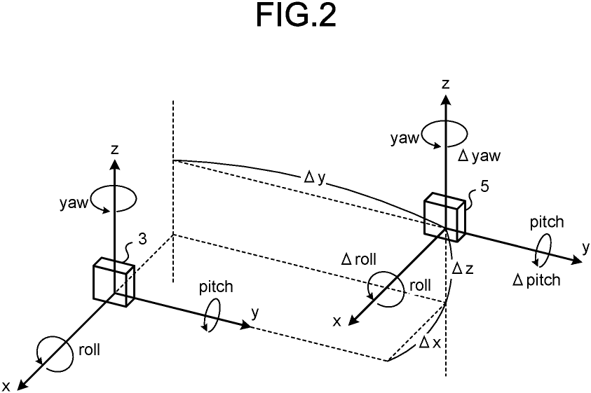

FIG. 1 is a schematic explanatory diagram of an information processing method according to an embodiment of the present disclosure. Furthermore, FIG. 2 is an explanatory diagram of calibration parameters.

The information processing method according to the embodiment of the present disclosure relates to calibration of a plurality of sensors that is mounted on a mobile apparatus. As illustrated in FIG. 1, the mobile apparatus is, for example, a vehicle. Each of the sensors is an in-vehicle sensor that is mounted on the vehicle, and is, for example, a millimeter wave radar.

Information processing according to the embodiment is performed by an information processing device 10 mounted on a vehicle Vₛ. Note that hereinafter, the vehicle Vₛ may be referred to as “host vehicle Vₛ”.

Incidentally, in an information processing system that uses combined information acquired from a plurality of in-vehicle sensors, if a relative arrangement relationship between the in-vehicle sensors, that is, a relative position and a relative angle are not grasped accurately, accuracy in combining information may be reduced.

Meanwhile, in a vehicle component such as the in-vehicle sensor, a mounting position, a mounting angle, and the like may change from the beginning due to change over years, vibration, and the like. Therefore, it is preferable to appropriately perform calibration during traveling of a vehicle or the like to always accurately grasp the relative arrangement relationship between the in-vehicle sensors.

As an existing technology for performing such calibration of the in-vehicle sensor, for example, a technology for performing calibration on the basis of map information is known. However, the existing technology based on the map information cannot perform calibration in an area that has no corresponding map information.

Furthermore, the calibration cannot be performed in an area that has a difference in the map information due to a change in environment caused by construction, disaster, or the like, even if the area has the corresponding map information. In addition, even in an area that has no difference in the map information, in order to accurately perform the calibration, it is necessary to accurately estimate the position and attitude of the host vehicle Vₛ in the first place.

Therefore, in the information processing method according to the embodiment, results of measurement are acquired from a plurality of sensors mounted on the host vehicle Vₛ, other vehicles other than the host vehicle Vₛ, extracted from the results of the measurement are used as reference points, and calibration parameters between the sensors are generated. Hereinafter, in an example, each of the other vehicles will be described as a reference point, but the reference point is not limited to the vehicle, and may be, for example, a motorcycle, a bicycle, a pedestrian, or the like. The motorcycle, bicycle, pedestrian, and the like that are used as the reference points are smaller than the vehicles, and therefore can be set as the reference points regardless of the width thereof, unlike the vehicles.

In other words, in the information processing method according to the embodiment, the other vehicles that are traveling, other than the host vehicle Vₛ are used as the references for calibration, and therefore, the calibration between the sensors is directly performed on the basis of only information from the sensors without using the position and attitude of the host vehicle Vₛ. Specifically, the sensors target the other vehicles being traveling, and a relative position and a relative angle between the sensors are estimated so that both of the sensors have the same view.

More specifically, as illustrated in FIG. 1, in the information processing method according to the embodiment, the information processing device 10 generates the calibration parameters between, for example, a first millimeter wave radar 3 and a second millimeter wave radar 5 mounted on the host vehicle Vₛ, while traveling of the host vehicle Vₛ. Note that the first millimeter wave radar 3 and the second millimeter wave radar 5 may be hereinafter referred to as “both radars 3 and 5”.

Here, the calibration parameters between both radars 3 and 5 are parameters for six axes indicating the relative position and the relative angle between both radars 3 and 5.

Specifically, as illustrated in FIG. 2, the calibration parameters are Δx, Δy, Δz, Δroll, Δpitch, and Δyaw that represent relative amounts of an x direction, y direction, and z direction, and a roll angle, pitch angle, and yaw angle around the three axes, of each of both radars 3 and 5. These six unknown variables can be calculated if there are four points that can be simultaneously detected from both radars 3 and 5.

The description returns to FIG. 1. Therefore, in the information processing method according to the embodiment, as illustrated in FIG. 1, the information processing device 10 determines whether both radars 3 and 5 have simultaneously detected at least four or more other vehicles Vₙ and V_{f}, for example, at the start of a predetermined calibration cycle (Step S1).

Then, when at least four or more other vehicles Vₙ and V_{f} are detected, the information processing device 10 generates the calibration parameters between both radars 3 and 5, with these vehicles Vₙ and V_{f} as the reference points (Step S2) .

At this time, for each of the other vehicles V_{f} distant from the host vehicle Vₛ, the information processing device 10 handles, for example, one reliable detection point of detection points of the vehicle V_{f}, as “low accuracy reference point”. Meanwhile, for the vehicle Vₙ of the other vehicles near the host vehicle Vₛ, the information processing device 10 handles one of the detection points of the vehicle Vₙ corresponding to an edge of the vehicle Vₙ, as “high accuracy reference point”.

For example, for each of the other vehicles V_{f} distant, it is difficult to identify whether the detection points are reflected from which points on the object, in view of the resolution of the radar. Therefore, “low accuracy reference point” includes at least ambiguity in vehicle width of the vehicle V_{f}.

However, for the vehicle Vₙ of the other vehicles, which is near, it is possible to acquire even the shape of the vehicle Vₙ. Therefore, the information processing device 10 uses the edge of the vehicle Vₙ as the “high accuracy reference point” to avoid the ambiguity due to the “low accuracy reference point”, ensuring accuracy of the calibration.

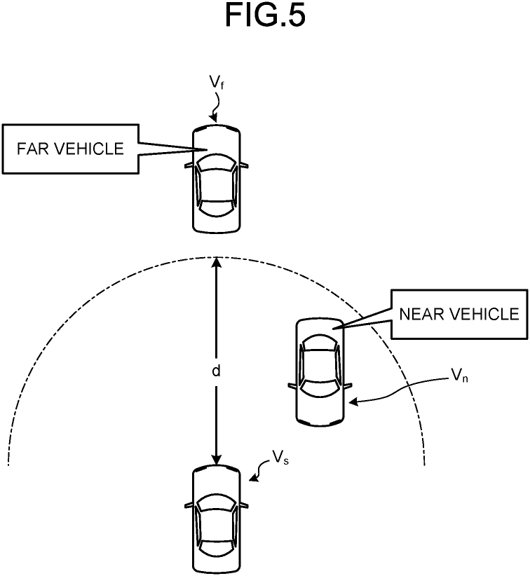

Note that such an extraction process for each reference point will be described later with reference to FIGS. 5 to 7. Furthermore, hereinafter, the vehicle Vₙ of the other vehicles may be referred to as “near vehicle”. Similarly, the other vehicles V_{f} may be referred to as “far vehicles”.

Then, the information processing device 10 outputs the generated calibration parameters to, for example, an electronic control unit (ECU) mounted on the vehicle Vₛ. Then, the ECU uses the calibration parameters output from the information processing device 10, combines the results of the measurement by the first millimeter wave radar 3 and the second millimeter wave radar 5 while correcting the measurement results, and performs, for example, vehicle control related to autonomous drive, drive assistance, and the like.

As described above, in the information processing method according to the embodiment, the results of measurement are acquired from the first millimeter wave radar 3 and the second millimeter wave radar 5 that are mounted on the host vehicle Vₛ, the other vehicles Vₙ and V_{f} other than the host vehicle Vₛ, extracted from the results of the measurement are used as the reference points, and the calibration parameters between both radars 3 and 5 are generated.

Therefore, according to the information processing method of the embodiment, calibration can be performed without being affected by the presence/absence of the map information or a change in environment, and without depending on the position and attitude of the host vehicle Vₛ.

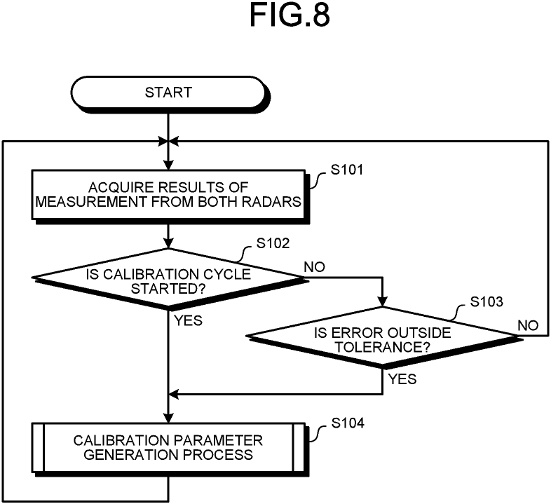

Note that in the above description, for example, the calibration is performed at the start of the predetermined calibration cycle, but is not limited thereto. For example, after the calibration, the results of the measurement by one of the radars may be projected onto a coordinate system of the other radar by using the calibration parameters while the host vehicle Vₛ is traveling to evaluate an error in the coordinate system, and if the error is outside a tolerance, the calibration may be performed again. This example will be described later with reference to FIG. 8.

An exemplary configuration of an information processing system 1 to which the information processing method according to the embodiments described above is applied will be described more specifically below.

### 2. Configuration of Information Processing System

### 2-1. Overall Configuration

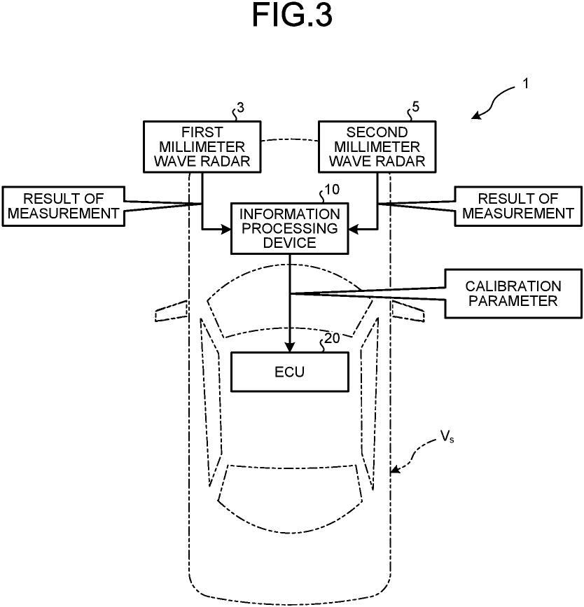

First, an overall configuration of the information processing system 1 will be described. FIG. 3 is a diagram illustrating the exemplary configuration of the information processing system 1 according to an embodiment of the present disclosure. As illustrated in FIG. 3, the information processing system 1 includes the first millimeter wave radar 3, the second millimeter wave radar 5, the information processing device 10, and the ECU 20.

The first millimeter wave radar 3 and the second millimeter wave radar 5 are, for example, distance measuring sensors provided near both left and right ends of the front portion of the host vehicle Vₛ.

The information processing device 10 is a device that acquires the results of measurement from the first millimeter wave radar 3 and the second millimeter wave radar 5, uses the other vehicles Vₙ and V_{f} other than the host vehicle Vₛ, extracted from the results of the measurement, as the reference points, and generates the calibration parameters between both radars 3 and 5.

The ECU 20 is a device that uses the calibration parameters generated by the information processing device 10, combines the results of the measurement by the first millimeter wave radar 3 and the second millimeter wave radar 5 while correcting the measurement results, and performs, for example, vehicle control related to autonomous drive, drive assistance, and the like.

The first millimeter wave radar 3, the second millimeter wave radar 5, the information processing device 10, and the ECU 20 are communicably connected to each other via an in-vehicle network such as a controller area network (CAN). Note that a connection form of the in-vehicle network may be wired or wireless.

In addition, FIG. 3 illustrates two millimeter wave radars of the first millimeter wave radar 3 and the second millimeter wave radar 5, but the number of millimeter wave radars is not limited thereto, and may be three or more. Likewise, a plurality of ECUs 20 may be provided.

### 2-2. Configuration of Information Processing Device

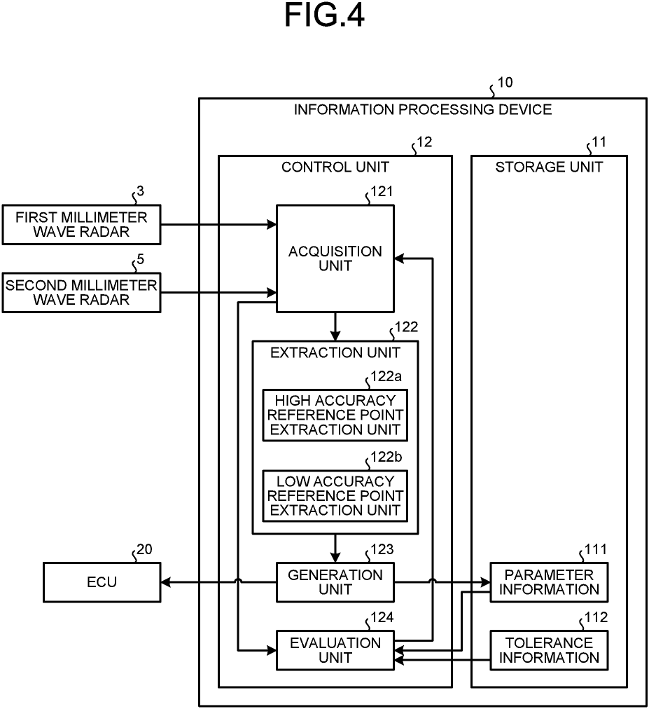

Next, an exemplary configuration of the information processing device 10 will be described. FIG. 4 is a block diagram illustrating the exemplary configuration of the information processing device 10 according to an embodiment of the present disclosure. Note that FIG. 4 illustrates only component elements necessary for description of the features of the present embodiment, and descriptions of general component elements are omitted.

In other words, the component elements illustrated in FIG. 4 show a functional concept and are not necessarily physically configured as illustrated. For example, specific forms of distribution or integration of blocks are not limited to those illustrated, and all or some thereof can be configured by being functionally or physically distributed or integrated, in any units, according to various loads or usage conditions.

Furthermore, in the description with reference to FIG. 4, the description of component elements having been already described are simplified or omitted in some cases.

As illustrated in FIG. 4, the information processing device 10 includes a storage unit 11 and a control unit 12. The storage unit 11 is implemented by, for example, a semiconductor memory device such as a random access memory (RAM), read only memory (ROM), or flash memory, or a storage device such as a hard disk or optical disk. In the example illustrated in FIG. 4, the storage unit 11 stores parameter information 111 and tolerance information 112.

The parameter information 111 is information that includes the calibration parameters generated by a generation unit 123 which is described later. The tolerance information 112 is information that defines an error tolerance in the results of measurement by the first millimeter wave radar 3 and the second millimeter wave radar 5 when the results of the measurement are projected into the same coordinate system by using the calibration parameters, and includes thresholds or the like.

The control unit 12 is a controller, and is implemented by, for example, executing various programs stored in the storage unit 11 by a central processing unit (CPU), a micro processing unit (MPU), or the like, with the RAM as a working area. In addition, the control unit 12 can be implemented by an integrated circuit such as an application specific integrated circuit (ASIC) or a field programmable gate array (FPGA).

The control unit 12 includes an acquisition unit 121, an extraction unit 122, the generation unit 123, and an evaluation unit 124, and implements or performs the function and operation of the information processing which is described below.

The acquisition unit 121 acquires the results of the measurement by the first millimeter wave radar 3 and the second millimeter wave radar 5. In addition, the acquisition unit 121 outputs the acquired results of the measurement to the extraction unit 122 and the evaluation unit 124.

When at least four or more other vehicles Vₙ and V_{f} are simultaneously detected within the viewing angles of both radars 3 and 5 on the basis of the results of the measurement output from the acquisition unit 121, the extraction unit 122 extracts the high accuracy reference point and the low accuracy reference points as described above.

The extraction unit 122 includes a high accuracy reference point extraction unit 122a and a low accuracy reference point extraction unit 122b. The high accuracy reference point extraction unit 122a extracts the high accuracy reference point. The low accuracy reference point extraction unit 122b extracts the low accuracy reference points.

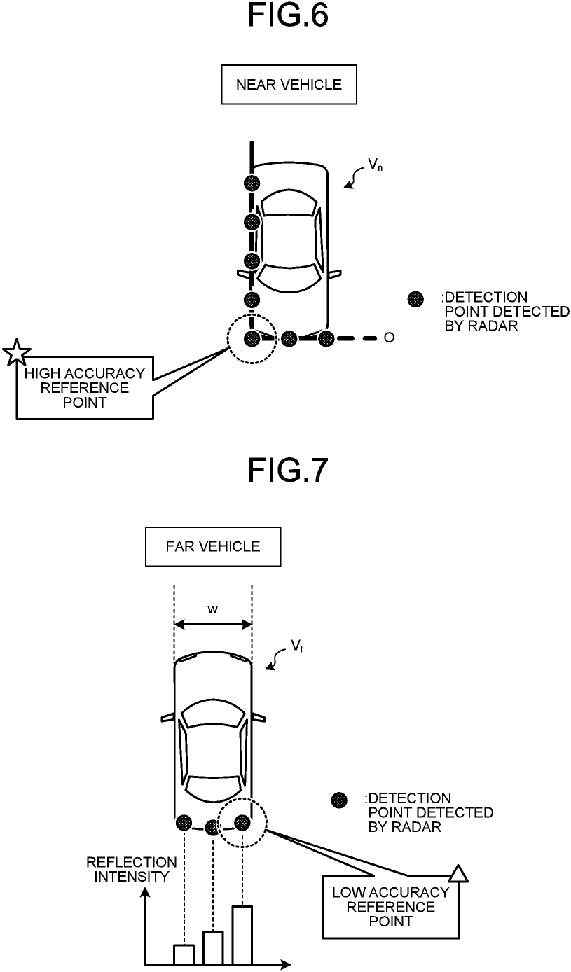

Here, the extraction process performed by the extraction unit 122 will be described more specifically with reference to FIGS. 5 to 7. FIG. 5 is an explanatory diagram (1) of the extraction process. FIG. 6 is an explanatory diagram (2) of the extraction process. FIG. 7 is an explanatory diagram (3) of the extraction process.

As illustrated in FIG. 5, on the basis of the results of the measurement output from the acquisition unit 121, the extraction unit 122 first identifies, as “near vehicle”, the vehicle Vₙ of the other vehicles at least partially positioned within a predetermined distance d from the host vehicle Vₛ. The distance d is, for example, 10 m.

Furthermore, the extraction unit 122 identifies, as “far vehicles”, each of the other vehicles V_{f} positioned farther than the predetermined distance d from the host vehicle Vₛ.

Then, as illustrated in FIG. 6, for the vehicle Vₙ of the other vehicles that is “near vehicle”, the high accuracy reference point extraction unit 122a extracts the high accuracy reference point, on the basis of the results of the measurement by the first millimeter wave radar 3 and the second millimeter wave radar 5.

Specifically, the high accuracy reference point extraction unit 122a estimates the shape of the vehicle Vₙ from the detection points related to the vehicle Vₙ, and extracts the detection point corresponding to the edge of the vehicle Vₙ from the estimated shape, as the high accuracy reference point.

The term “edge” here is an end point farthest from the center portion of the shape of vehicle Vₙ, in other words, an end point closest to the host vehicle Vₛ. In the example of FIG. 6, the edge corresponds to a corner of a substantially L-shaped contour O of the vehicle Vₙ.

Furthermore, as illustrated in FIG. 7, for each of the other vehicles V_{f} that are “far vehicles”, the low accuracy reference point extraction unit 122b extracts the low accuracy reference point, on the basis of results of the measurement by the first millimeter wave radar 3 and the second millimeter wave radar 5.

Specifically, the low accuracy reference point extraction unit 122b extracts a detection point having the highest reliability, from the detection points related to the vehicle V_{f}, as the low accuracy reference point. In the example of FIG. 7, the reliability depends on a reflection intensity at each detection point, and the detection point having the highest reflection intensity of the detection points related to the vehicle V_{f} is extracted as the low accuracy reference point. Note that as described above, the low accuracy reference point includes ambiguity in vehicle width w. The vehicle width w is, for example, approximately 1.5 to 2.0 m.

The description returns to FIG. 4. In addition, the extraction unit 122 outputs the extracted reference points to the generation unit 123. The generation unit 123 generates the calibration parameters between the first millimeter wave radar 3 and the second millimeter wave radar 5, on the basis of the reference points output from the extraction unit 122.

Furthermore, the generation unit 123 stores the generated calibration parameters in the parameter information 111 and outputs the generated calibration parameters to the ECU 20.

The evaluation unit 124 uses calibration parameters in the parameter information 111 to project results of the measurement by one of the first millimeter wave radar 3 and the second millimeter wave radar 5 onto the coordinate system of the other millimeter wave radar, and thereby evaluates the error in the results of the measurement by both radars.

Specifically, on the basis of the tolerance information 112, the evaluation unit 124 determines whether the error in the results of the measurement by both radars 3 and 5 when projection onto the same coordinate system is outside the tolerance. Then, when the error is outside the tolerance, the evaluation unit 124 causes the extraction unit 122 to extract the reference points again on the basis of a result of the acquisition by the acquisition unit 121, and causes the generation unit 123 to generate the calibration parameters again.

### 3. Processing Procedure Performed by Information Processing Device

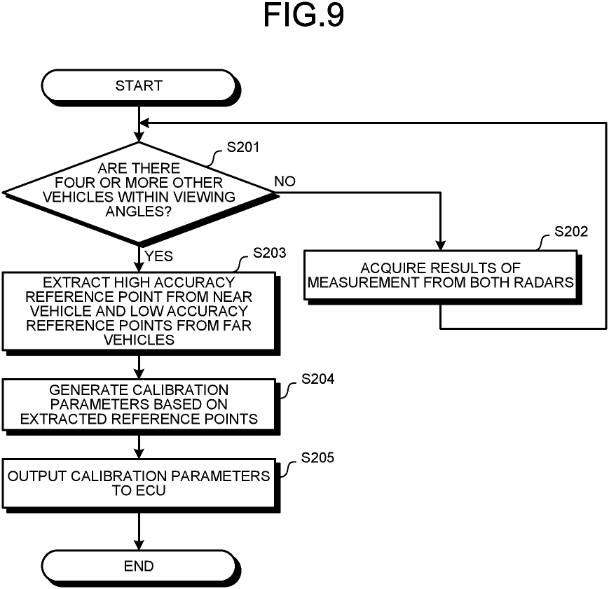

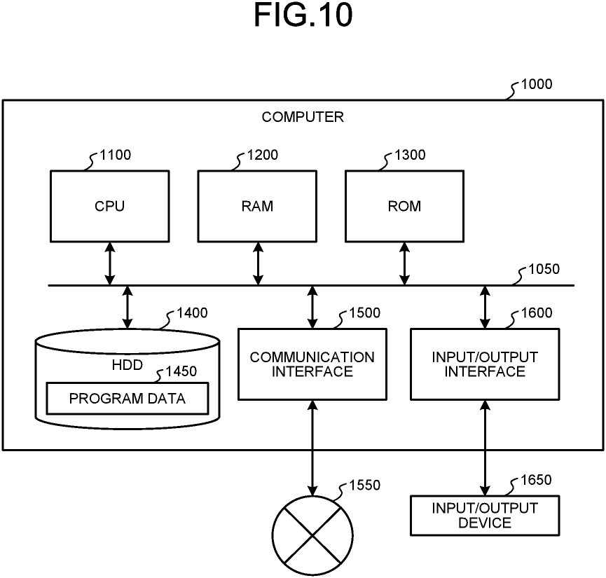

Next, a processing procedure performed by the information processing device 10 according to the embodiment will be described with reference to FIGS. 8 and 9. FIG. 8 is a flowchart illustrating the processing procedure performed by the information processing device 10 according to an embodiment of the present disclosure. Furthermore, FIG. 9 is a flowchart illustrating a procedure for a calibration parameter generation process illustrated in FIG. 8.

As illustrated in FIG. 8, the acquisition unit 121 first acquires the results of the measurement by both radars 3 and 5 (Step S101). Then, it is determined whether the predetermined calibration cycle is started (Step S102).

Here, when the calibration cycle is not started (Step S102, No), the evaluation unit 124 subsequently determines whether the error in the results of the measurement by both radars 3 and 5 is outside the tolerance (Step S103).

Then, when the error is not outside the tolerance (Step S103, No), the control unit 12 repeats the processing from Step S101.

On the other hand, when the calibration cycle is started (Step S102, Yes) or when the error is outside the tolerance (Step S103, Yes), the calibration parameter generation process is performed (Step S104).

Then, after the calibration parameter generation processing is performed, the control unit 12 repeats the processing from Step S101.

In the calibration parameter generation process, as illustrated in FIG. 9, the extraction unit 122 determines whether there are at least four or more other vehicles Vₙ and V_{f} within the viewing angles of both radars 3 and 5 (Step S201).

Here, when there are not four or more other vehicles Vₙ and V_{f} (Step S201, No), the acquisition unit 121 acquires the results of the measurement by both radars 3 and 5 (Step S202), and repeats the processing from Step S201.

On the other hand, when there are four or more other vehicles Vₙ and V_{f} (Step S201, Yes), the extraction unit 122 extracts the high accuracy reference point from the near vehicle, and the low accuracy reference points from the far vehicles (Step S203). When there are a large number of other vehicles Vₙ and V_{f}, as in a city street, at least any four other vehicles Vₙ and V_{f} are selected that are likely to be used as the reference points, on the basis of the reliability of the results of the measurement, a positional relationship between the vehicle Vₛ and the other vehicles Vₙ and V_{f}, a relative speed between the vehicle Vₛ and the other vehicles Vₙ and V_{f}, and the like.

Then, the generation unit 123 generates the calibration parameters on the basis of the extracted reference points (Step S204). Then, the generation unit 123 outputs the generated calibration parameters to the ECU 20 (Step S205), and finishes one cycle of the calibration parameter generation process.

### 4. Modifications

Note that the embodiments described above can include some modifications.

### 4-1. First Modification

In the embodiments described above, the in-vehicle sensor is, for example, the millimeter wave radar, but is not limited to this example. The in-vehicle sensor may be, for example, light detection and ranging, laser imaging detection and ranging (LiDAR) that reads a three-dimensional structure of a surrounding environment of the host vehicle Vₛ. The LiDAR emits laser light such as an infrared laser to surrounding objects and measures a time until reflected laser beam is returned to detect a distance or a relative speed to the surrounding objects. The information processing device 10 can perform calibration between the LiDARs by using, as the detection points, information about the other vehicles Vₙ and V_{f} acquired by the LiDARs.

### 4-2. Second Modification

In addition, in the examples in the drawings of the embodiments described above, the vehicles Vₛ, Vₙ, and V_{f} are all passenger cars, but may include, for example, a motorcycle. The motorcycle reduces the ambiguity in the vehicle width w, and therefore, the accuracy of calibration can be further increased.

### 4-3. Third Modification

In addition, in the examples in the drawings of the embodiments described above, the other vehicles Vₙ and V_{f} are also traveling, but the other vehicles Vₙ and V_{f} preferably move relative to the host vehicle Vₛ. Therefore, the other vehicles Vₙ and V_{f} may be, for example, parked or stopped relative to the traveling host vehicle Vₛ.

### 4-4. Other Modifications

Furthermore, of the processes described in the above embodiments, all or some of processes described to be performed automatically may be performed manually, or all or some of processes described to be performed manually may be performed automatically by a known method. In addition, the processing procedures, specific names, and information including various data and parameters, which are described in the above description or illustrated in the drawings, can be appropriately changed unless otherwise specified. For example, various information illustrated in the drawings are not limited to the illustrated information.

Furthermore, the component elements of the devices are illustrated on the basis of a functional concept and are not necessarily required to be physically configured as illustrated. In other words, specific forms of distribution or integration of the devices are not limited to those illustrated, and all or some of the devices may be configured by being functionally or physically distributed or integrated in appropriate units, according to various loads or usage conditions. For example, the extraction unit 122 and the generation unit 123 illustrated in FIG. 4 may be integrated.

Furthermore, the embodiments having been described above can be appropriately combined within a range consistent with process contents. Furthermore, the orders of the steps illustrated in the sequence diagrams or flowcharts of the present embodiment can be changed appropriately.

### 5. Hardware Configuration

The information processing device 10 according to the embodiments described above are implemented by a computer 1000 having a configuration as illustrated in FIG. 10. FIG. 10 is a hardware configuration diagram illustrating an example of the computer 1000 implementing the functions of the information processing device 10. The computer 1000 includes a CPU 1100, a RAM 1200, a ROM 1300, a hard disk drive (HDD) 1400, a communication interface 1500, and an input/output interface 1600. The respective units of the computer 1000 are connected by a bus 1050.

The CPU 1100 is operated on the basis of programs stored in the ROM 1300 or the HDD 1400 and controls the respective units. For example, the CPU 1100 deploys a program stored in the ROM 1300 or the HDD 1400 to the RAM 1200 and executes processing corresponding to various programs.

The ROM 1300 stores a boot program, such as a basic input output system (BIOS), executed by the CPU 1100 when the computer 1000 is booted, a program depending on hardware of the computer 1000, and the like.

The HDD 1400 is a computer-readable recording medium that non-transitorily records the programs executed by the CPU 1100, data used by the programs, and the like. Specifically, the HDD 1400 is a recording medium that records an information processing program according to the present disclosure that is an example of program data 1450.

The communication interface 1500 is an interface for connecting the computer 1000 and an external network 1550 (e.g., CAN, the Internet, etc.). For example, the CPU 1100 receives data from another device or transmits data generated by the CPU 1100 to another device, via the communication interface 1500.

The input/output interface 1600 is an interface for connecting an input/output device 1650 and the computer 1000. For example, the CPU 1100 receives data from an input device such as a keyboard or mouse via the input/output interface 1600. In addition, the CPU 1100 transmits data to an output device such as a display, speaker, or printer via the input/output interface 1600. Furthermore, the input/output interface 1600 may function as a media interface that reads a program or the like recorded on a predetermined recording medium. The medium includes, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, when the computer 1000 functions as the information processing device 10 according to the embodiment, the CPU 1100 of the computer 1000 executes the information processing program loaded on the RAM 1200 to implement the function of the control unit 12. Furthermore, the HDD 1400 stores the information processing program according to the present disclosure and data in the storage unit 11. Note that the CPU 1100 executes the program data 1450 read from the HDD 1400, but in another example, the CPU 1100 may acquire the programs from another device via the external network 1550. Furthermore, part or all of the configuration of the information processing device 10 may be provided in an external device such as a cloud server in addition to a processor such as a CPU or an ECU mounted on the vehicle Vₛ. When the program data 1450 is executed by the external device such as the cloud server, the results of the measurement by the plurality of sensors are transmitted to the external device via the external network 1550, and results of processing performed by the external device are acquired via the external network 1550.

### 6. Conclusion

As described above, according to an embodiment of the present disclosure, the information processing device 10 includes the generation unit 123 that acquires the results of measurement from the first millimeter wave radar 3 and the second millimeter wave radar 5 (corresponding to an example of “a plurality of sensors”) mounted on the host vehicle Vₛ (corresponding to an example of “one mobile apparatus”), that uses, as the reference points, the other vehicles Vₙ and V_{f} (corresponding to an example of “other mobile apparatuses”) other than the host vehicle Vₛ, extracted from the results of the measurement, and that generates the calibration parameters between both radars 3 and 5. Therefore, calibration can be performed without being affected by the presence/absence of the map information or a change in environment, and without depending on the position and attitude of the mobile apparatus itself.

Although the embodiments of the present disclosure have been described above, the technical scope of the present disclosure is not limited to the embodiments described above and various modifications can be made without departing from the spirit and scope of the present disclosure. Furthermore, the component elements of different embodiments and modifications may be suitably combined with each other.

Furthermore, the effects in the embodiments described herein are merely examples, the present invention is not limited to these effects, and other effects may also be provided.

Note that the present technology can also have the following configurations.
(1) An information processing device comprising
   a generation unit that acquires results of measurement from a plurality of sensors mounted on one mobile apparatus, uses, as reference points, other mobile apparatuses other than the one mobile apparatus extracted from the results of measurement, and generates calibration parameters between the sensors.
(2) The information processing device according to (1), wherein
   the generation unit
   uses at least four or more of the other mobile apparatuses as the reference points.
(3) The information processing device according to (2), wherein
   the generation unit
   uses at least one or more of the other mobile apparatuses within a predetermined distance from the one mobile apparatus, as the reference point.
(4) The information processing device according to (2) or (3), wherein
   the generation unit
   generates the calibration parameters for six-axis directions of the sensor.
(5) The information processing device according to any one of (1) to (4), wherein
   the generation unit
   sets the reference points different according to distances from the one mobile apparatus to the other mobile apparatuses.
(6) The information processing device according to (5), wherein
   the generation unit
   uses, for the other mobile apparatuses within a predetermined distance, detection points corresponding to edges of the other mobile apparatuses, of the detection points of the other mobile apparatuses detected by the sensors, as the reference points.
(7) The information processing device according to (5) or (6), wherein
   the generation unit
   uses, for the other mobile apparatuses farther than a predetermined distance, the detection points having the highest reliability, of the detection points of the other mobile apparatuses detected by the sensors, as the reference points.
(8) The information processing device according to (7), wherein
   the reliability depends on reflection intensity at each of the detection points.
(9) The information processing device according to any one of (1) to (8), wherein
   the generation unit
   generates the calibration parameters at predetermined intervals.
(10) The information processing device according to any one of (1) to (9), wherein
   the generation unit
   generates the calibration parameters when an error in the results of measurement by the sensors is outside a predetermined tolerance.
(11) The information processing device according to (10), further comprising
   an evaluation unit that uses the calibration parameters to project the results of measurement by one sensor of the plurality of sensors onto a coordinate system of the other sensor other than the one sensor, and thereby evaluates the error in the results of measurement by the one sensor and the other sensor, wherein
   the generation unit
   generates the calibration parameters when the evaluation unit determines that the error is outside the tolerance.
(12) The information processing device according to any one of (1) to (11), wherein
   the other mobile apparatuses are each an object moving relative to the one mobile apparatus.
(13) The information processing device according to (12), wherein
   the other mobile apparatuses are each an object traveling.
(14) The information processing device according to any one of (1) to (13), wherein
   the sensors are each a millimeter wave radar.
(15) The information processing device according to any one of (1) to (14), wherein
   the one mobile apparatus is a vehicle.
(16) An information processing method comprising
   acquiring results of measurement from a plurality of sensors mounted on one mobile apparatus, using, as reference points, other mobile apparatuses other than the one mobile apparatus extracted from the results of measurement, and generating calibration parameters between the sensors.
(17) An information processing program causing a computer to perform
   acquiring results of measurement from a plurality of sensors mounted on one mobile apparatus, using, as reference points, other mobile apparatuses other than the one mobile apparatus extracted from the results of measurement, and generating calibration parameters between the sensors.

REFERENCE SIGNS LIST

| | |
|---|---|
| 1 | INFORMATION PROCESSING SYSTEM |
| 3 | FIRST MILLIMETER WAVE RADAR |
| 5 | SECOND MILLIMETER WAVE RADAR |
| 10 | INFORMATION PROCESSING DEVICE |
| 111 | PARAMETER INFORMATION |
| 112 | TOLERANCE INFORMATION |
| 121 | ACQUISITION UNIT |
| 122 | EXTRACTION UNIT |
| 122 a | HIGH ACCURACY REFERENCE POINT EXTRACTION UNIT |
| 122 b | LOW ACCURACY REFERENCE POINT EXTRACTION UNIT |
| 123 | GENERATION UNIT |
| 124 | EVALUATION UNIT |
| 20 | ECU |

1. 5 An information processing device comprising
a generation unit that acquires results of measurement from a plurality of sensors mounted on one mobile apparatus, uses, as reference points, other mobile apparatuses other than the one mobile apparatus extracted from the results of measurement, and generates calibration parameters between the sensors.

2. The information processing device according to claim 1, wherein
the generation unit
uses at least four or more of the other mobile apparatuses as the reference points.

3. The information processing device according to claim 2, wherein
the generation unit
uses at least one or more of the other mobile apparatuses within a predetermined distance from the one mobile apparatus, as the reference point.

4. The information processing device according to claim 2, wherein
the generation unit
generates the calibration parameters for six-axis directions of the sensor.

5. The information processing device according to claim 1, wherein
the generation unit
sets the reference points different according to distances from the one mobile apparatus to the other mobile apparatuses.

6. The information processing device according to claim 5, wherein
the generation unit
uses, for the other mobile apparatuses within a predetermined distance, detection points corresponding to edges of the other mobile apparatuses, of the detection points of the other mobile apparatuses detected by the sensors, as the reference points.

7. The information processing device according to claim 5, wherein
the generation unit
uses, for the other mobile apparatuses farther than a predetermined distance, the detection points having the highest reliability, of the detection points of the other mobile apparatuses detected by the sensors, as the reference points.

8. The information processing device according to claim 7, wherein
the reliability depends on reflection intensity at each of the detection points.

9. The information processing device according to claim 1, wherein
the generation unit
generates the calibration parameters at predetermined intervals.

10. The information processing device according to claim 1, wherein
the generation unit
generates the calibration parameters when an error in the results of measurement by the sensors is outside a predetermined tolerance.

11. The information processing device according to claim 10, further comprising
an evaluation unit that uses the calibration parameters to project the results of measurement by one sensor of the plurality of sensors onto a coordinate system of the other sensor other than the one sensor, and thereby evaluates the error in the results of measurement by the one sensor and the other sensor, wherein
the generation unit
generates the calibration parameters when the evaluation unit determines that the error is outside the tolerance.

12. The information processing device according to claim 1, wherein
the other mobile apparatuses are each an object moving relative to the one mobile apparatus.

13. The information processing device according to claim 12, wherein
the other mobile apparatuses are each an object traveling.

14. The information processing device according to claim 1, wherein
the sensors are each a millimeter wave radar.

15. The information processing device according to claim 1, wherein
the one mobile apparatus is a vehicle.

16. An information processing method comprising
acquiring results of measurement from a plurality of sensors mounted on one mobile apparatus, using, as reference points, other mobile apparatuses other than the one mobile apparatus extracted from the results of measurement, and generating calibration parameters between the sensors.

17. An information processing program causing a computer to perform
acquiring results of measurement from a plurality of sensors mounted on one mobile apparatus, using, as reference points, other mobile apparatuses other than the one mobile apparatus extracted from the results of measurement, and generating calibration parameters between the sensors.
